(19) United States
(12) Patent Application Publication
(10) Pub. No.: US 2008/0048488 A1
(43) Pub. Date: Feb. 28, 2008

(54) Weight reduction means for dual-wall rim

(75) Inventor: Hsuen-Chen Chen, Feng Yuan City (TW)

Correspondence Address: TROXELL LAW OFFICE PLLC, SUITE 1404, 5205 LEESBURG PIKE, FALLS CHURCH, VA, 22041, US

(73) Assignee: SHIENY CO., LTD.

(21) Appl. No.: 11/730,359

(22) Filed: Mar. 30, 2007

(30) Foreign Application Priority Data
Aug. 22, 2006 (TW) 095214833

(51) Int. Cl. B60B 21/06; B60B 1/02

(52) U.S. Cl. 301/58

(57) ABSTRACT

A weight reduction means for a dual-wall rim includes a structural frame disposed in the rim, multiple through holes to receive insertion of respective spoke connectors being disposed at where the dual-wall frame is located relatively to the spoke connectors; and one or a plurality of through holes between any abutted existing through holes on the dual-wall frame being punched at the same time when those existing through holes are initially punched without affecting the structural strength of the entire dual-wall rim without changing locations and numbers of those spoke connecting holes disposed on the inner circumference of the rim while maintaining the structural strength of the rim for weight reduction and cost saving purposes.

### BACKGROUND OF THE INVENTION

(a) Field of the Invention

The present invention is related to a weight reduction means for a dual-wall rim, and more particularly, to one that maintains the added structural strength and reduces the weight of the rim.

(b) Description of the Prior Art

Referring to FIG. 1 of the accompanying drawings, a rim 2 of the prior art is essentially comprised of having multiple spoke connection holes 21 directly punched on the inner circumference of the rim 2 so to allow multiple spoke connectors 3 to pass through the outer circumference of the rim 2 into those spoke connection holes 21 for multiple spokes 31 to be inserted into their respective lower end of the spoke connector 3. However, the rim 2 indicates a strict circular frame without any reinforced structure and the rim 2 completed with the fabrication, the structure of the entire rim is vulnerable to be twisted and distorted and further to affect the subsequent process of passing those spoke connectors 3 through their respective spoke connection holes 21 causing concerns about the structural strength when all of structural safety when all spokes 31 are inserted into those spoke connectors 3, and even about the structural safety in practical use once a tire 4 is inserted into the outer circumference of the entire rim 2.

An improvement as illustrated in FIGS. 2, 3, and 4 has been introduced by providing a dual-wall frame 22 on the inner circumference of the rim 2 without changing the locations and numbers of those spoke connection holes originally disposed on the inner circumference of the entire rim 2 so to prevent the rim from becoming twisted or deformed for paying firm structural strength. A through hole 221 to receive insertion of each spoke connector 3 is disposed at where the dual-wall frame 22 is located relatively to the spoke connector 21 for each spoke connector 3 to pass the through hole 221 disposed on the dual-wall frame 22 and then into the spoke connection hole 21 on the inner circumference of the rim 2 before inserting all the spokes 31 inserted into their respective bottoms of those spoke connectors 3.

However, the additional frame 22 causes the rim to get heavier and relatively increases the cost of material. Further improvement warrants today when the rim 2 is demanded to be light-weighted while providing better structural strength.

### SUMMARY OF THE INVENTION

The primary purpose of the present invention is to provide a weight reduction means for a dual-wall rim to reduce the overall weight of the rim and thus the production cost without changing locations and numbers of the spoke connection holes disposed on the inner circumference of the rim while maintaining the structural strength of the rim. To achieve the purpose, the improvement is made to the prior art of the dual-wall rim having a structural frame disposed in the rim and a through hole to receive insertion of each spoke connector is disposed at where the dual-wall frame is located relatively to the spoke connector by punching one or a plurality of through holes between any abutted existing through holes on the dual-wall frame.

Another purpose of the present invention is to provide a weight reduction means for a dual-wall rim that saves material cost. To achieve the purpose, residual bits collected from punching those existing and additional through holes can be reclaimed for resale and reuse to have additional income, and thus relatively reduce the material cost.

### BRIEF DESCRIPTION OF THE DRAWINGS

FIG. 1 is a sectional view of a rim of the prior art.

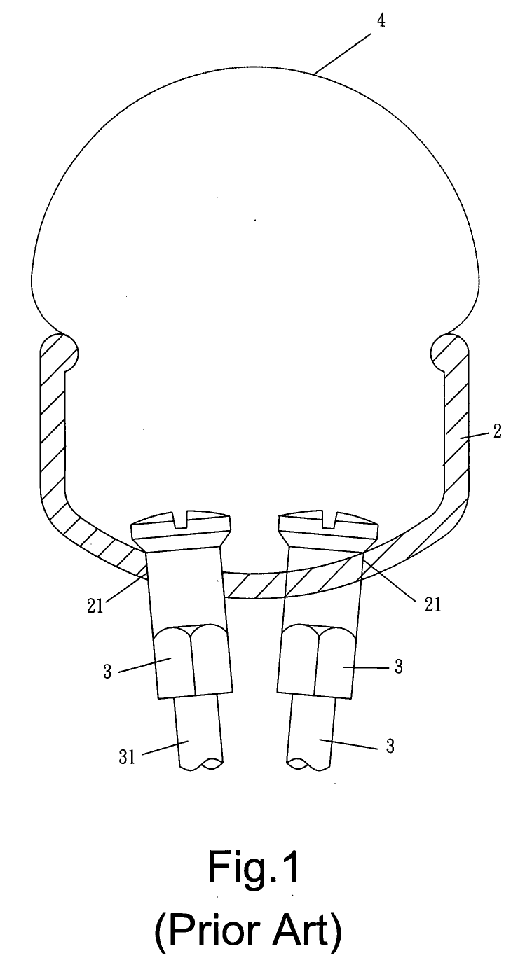

FIG. 2 is a perspective view showing a dual-wall rim of another prior art.

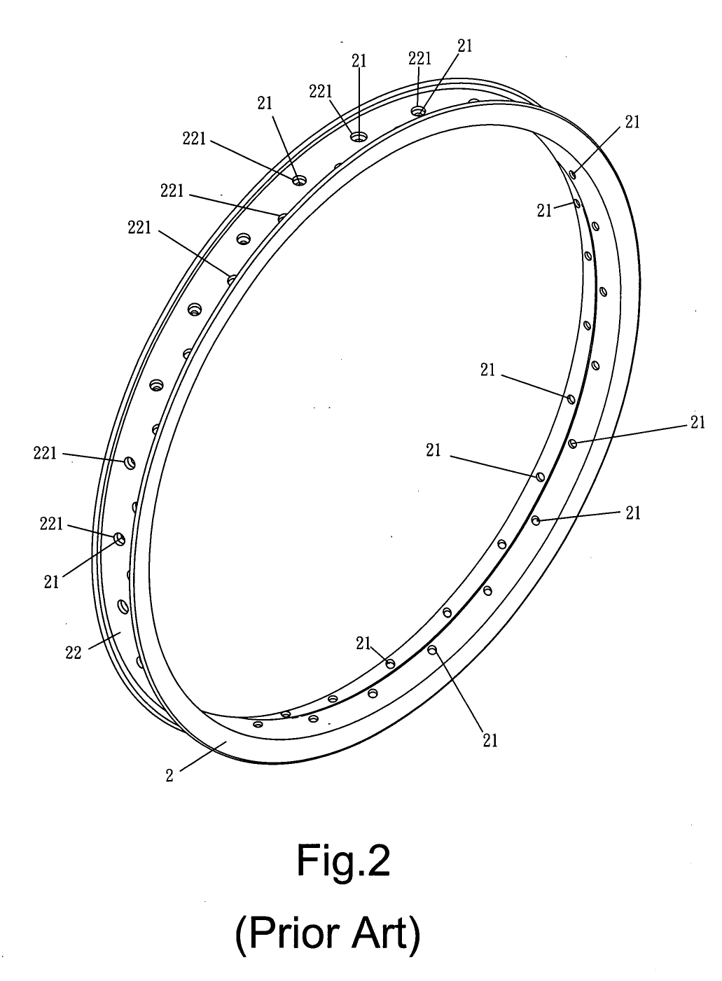

FIG. 3 is a bird's view showing a local part of the appearance of the dual-wall rim of another prior art.

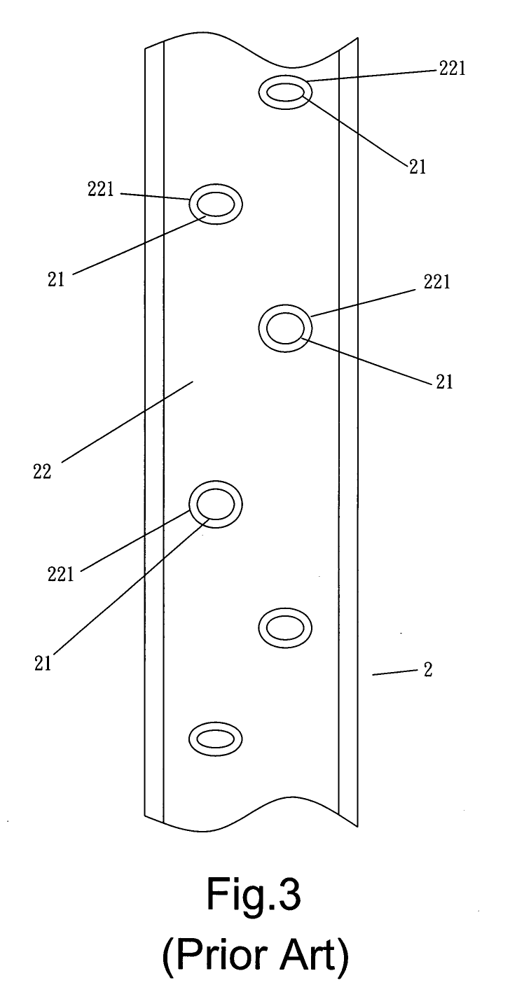

FIG. 4 is a sectional view showing the dual-wall rim of the prior art.

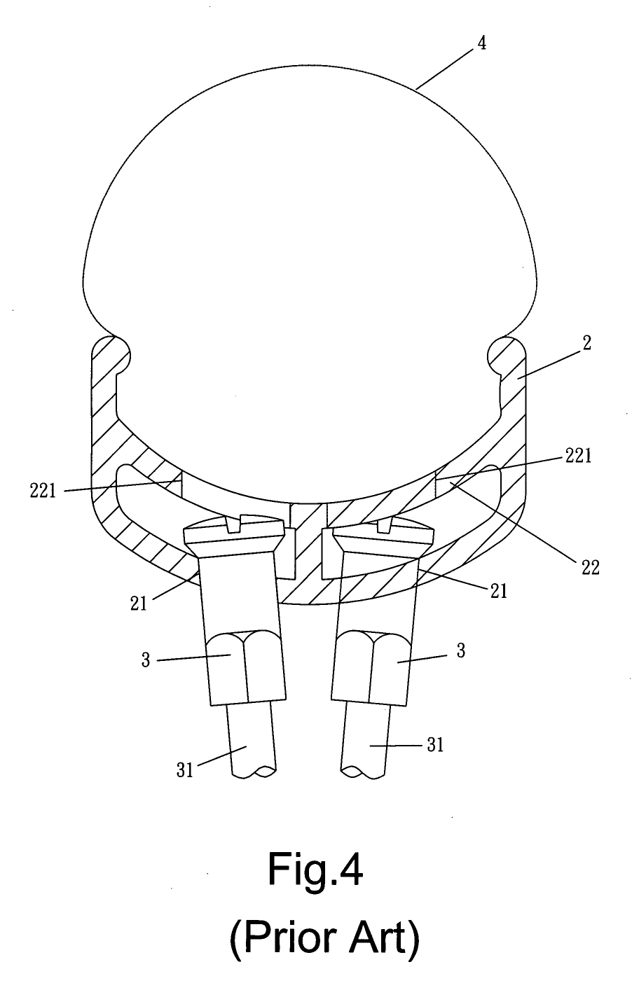

FIG. 5 is a perspective view showing a construction of the present invention.

FIG. 6 is a sectional view showing a local part of the construction of the present invention.

FIG. 7 is a bird's view showing a local part of the appearance of the present invention.

### DETAILED DESCRIPTION OF THE PREFERRED EMBODIMENTS

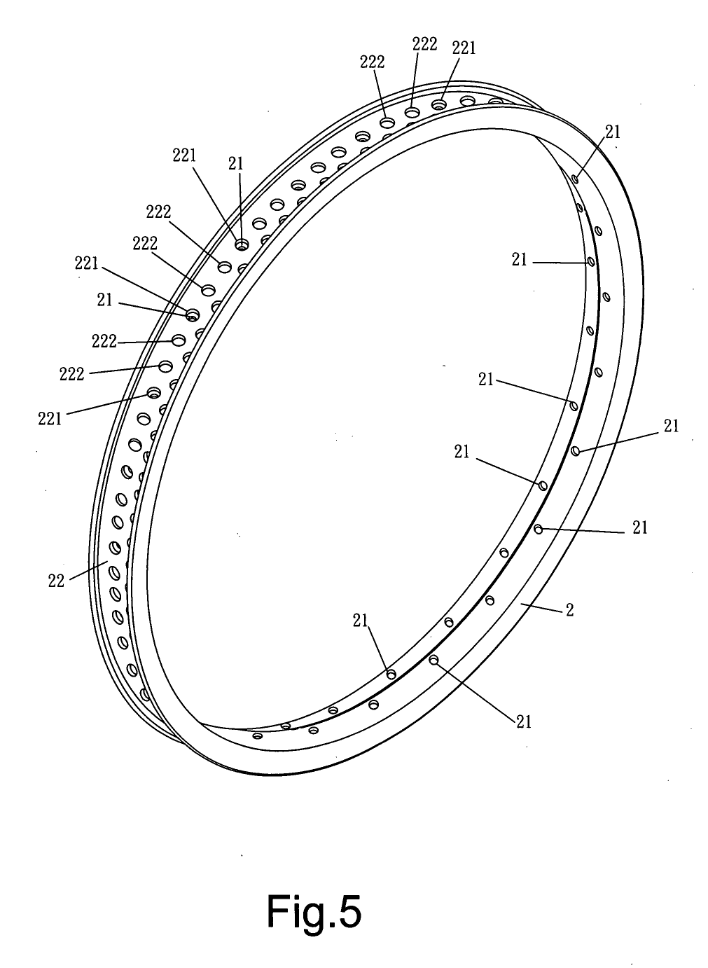

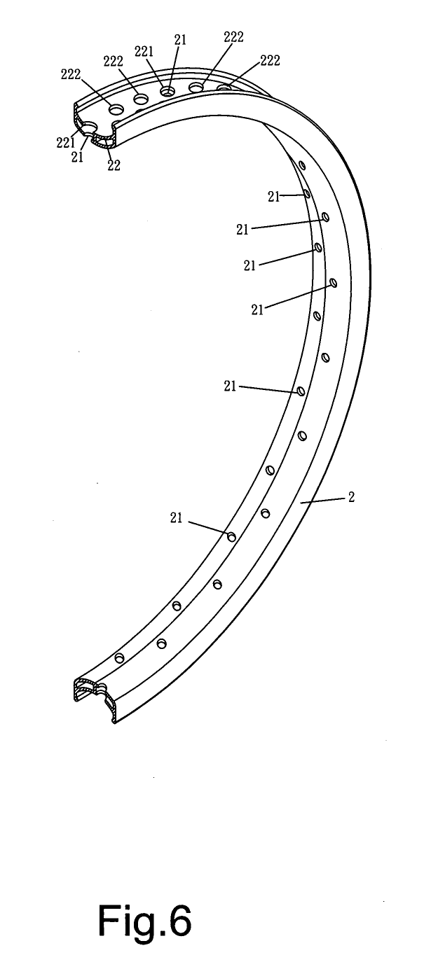

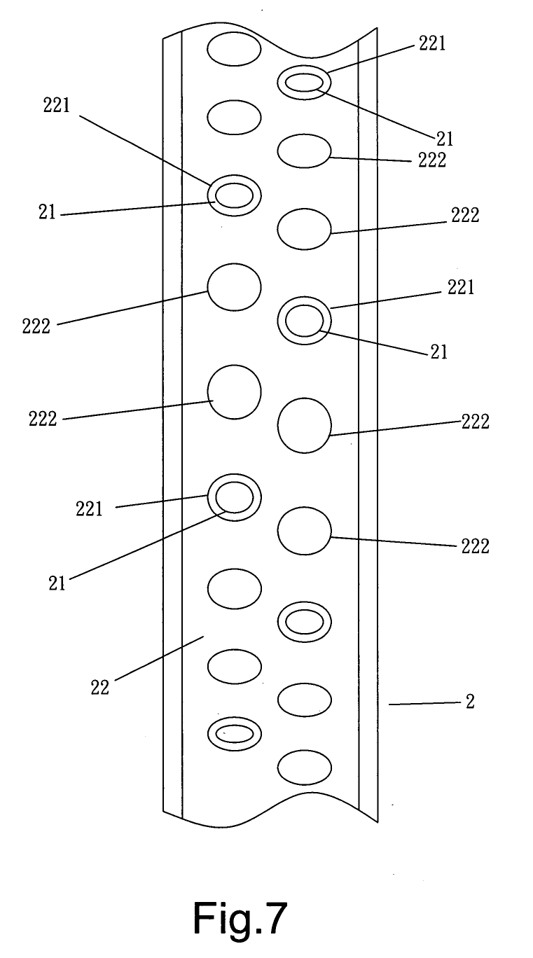

Referring to FIGS. 5, 6, and 7, a dual-wall rim 2 of the present invention is essentially comprised of a frame 22 disposed in the rim 2, multiple spoke connection holes 21 and multiple through holes 221 with each receiving insertion of each spoke connector 3 are disposed at where the dual-wall frame is located relatively to the spoke connector 3 in a construction similar to that of the prior art, and one or a plurality of additional through hole 222 is punched between any two abutted existing holes 221 without changing locations and numbers of those spoke connection holes 21 disposed on the inner circumference of the rim 2 and without changing locations and numbers of those through holes 221 receiving insertion of their respective spokes disposed at where those spoke connection holes 21 on the structural frame 22 in relation to the structural frame 22. Those additional through holes 222 are punched at the same time when those through holes 221 are initially punched without affecting the structural strength of the entire dual-wall rim without changing locations and numbers of those spoke connecting holes 21 disposed on the inner circumference of the rim 2 while maintaining the structural strength of the rim 2 for the rim 2 of the present invention to provide weight reduction and cost saving purposes.

I claim:

1. A weight reduction means for a dual-wall rim is comprised of a structural frame to provide firmer structure and better structural strength; multiple through holes to receive insertion of respective spoke connectors being disposed at where multiple spoke connection holes provided on the inner circumference of the rim in relation to the structural frame; and one or a plurality through holes being provided between any two abutted existing through holes to receive insertion of respective spoke connectors at the same time when those existing through holes being initially punched.
